(19) United States
(12) Patent Application Publication
(10) Pub. No.: US 2012/0267887 A1
(43) Pub. Date: Oct. 25, 2012

(54) Counterfeit Pharmaceutical Product Detection Method

(76) Inventor: Kenneth H. Pieri, Grand Island, NY (US)

(21) Appl. No.: 13/450,732

(22) Filed: Apr. 19, 2012

Related U.S. Application Data
(60) Provisional application No. 61/476,969, filed on Apr. 19, 2011.

(51) Int. Cl. B42D 15/00

(52) U.S. Cl. 283/81; 283/67

(57) ABSTRACT

A counterfeit pharmaceutical product detection method for detecting whether a drug is genuine or counterfeit. The method allows a consumer to check whether a drug is authentic or counterfeit by way of using personal identification number 25, a manufacturer identification number 24 and a sequential serial number 22. The method also includes a way for the consumer to test the pharmaceutical product to determine whether it is genuine or counterfeit.

### CROSS REFERENCE TO RELATED APPLICATION

This application claims priority to U.S. Provisional Application having Ser. No. 61/476,969, filed on Apr. 19, 2011 the entire disclosure of which is hereby incorporated herein by reference.

### FIELD OF INVENTION

This invention is directed to the detection of counterfeit pharmaceutical products.

### BACKGROUND OF INVENTION

The speed and ease at which products can be quickly manufactured and subsequently shipped around the world is remarkable. In this respect the world is becoming a smaller place. Unfortunately, this also facilitates the counterfeiting of goods and products by an increasing number of counterfeiters. These counterfeiters are becoming more and more savvy at counterfeiting. Counterfeit goods have also long been a source of problems and concerns in the clothing and recording industries. Now, however, counterfeiters have started counterfeiting pharmaceutical products. The counterfeiters are making counterfeit pharmaceutical products including drugs, medicines, pills, ointments, capsules, liquid medications, inhalers, etc. Indeed, no pharmaceutical product is immune from being counterfeited. One of the serious problems associated with counterfeited pharmaceutical products is that they may look and feel the same as the authentic products, and have matching colors, sizes, weights and markings that are exactly the same as the authentic pharmaceutical products. The counterfeited pharmaceutical products have external and internal packaging that is exactly the same as the authentic product packaging. In addition, the counterfeiters make both prescription and over the counter pharmaceutical products.

One of the more significant problems is that counterfeiters do not follow the strict rules and regulations that the Food and Drug Administration (FDA) has in place to ensure all pharmaceutical products are safe and contain the required dosage of the medication. Counterfeiters simply ignore all the FDA rules and regulations pertaining to pharmaceutical products. Thus, the counterfeiter may produce a pharmaceutical product for pennies a dose, whereas the genuine pharmaceutical product may cost hundreds of times more. This fact alone provides the counterfeiters with an enormous incentive to copy counterfeit pharmaceutical products and packaging.

Another problem with counterfeit pharmaceutical products is that the patient/consumer may unknowingly ingest the counterfeit product and suffer dire consequences. For example, the consumer that ingests the counterfeit pharmaceutical product may suffer serious side effects or may not receive a therapeutically effective dosage of the required drug that, in turn, might cause the consumer to die.

What is needed is a way to stave off the serious dangers of these counterfeit products. It would also be desirable to have a method for consumers to determine whether or not the pharmaceutical product about to be ingested is genuine or a counterfeit. It would also be desirable for the method to be easy to use and relatively inexpensive.

### SUMMARY OF THE INVENTION

This invention includes methods for detection of counterfeit pharmaceutical products. The counterfeit detection method and/or systems for counterfeit pharmaceutical products provides a way for the drug consumer to verify whether a pharmaceutical product is genuine or counterfeit by using a sequential serial number and/or a dye method which would be created by the drug or pharmaceutical company. The consumer should first obtain a “permanent” personal identification number (ID) similar to a Social Security number (for example, 9 digits or a combination of letters and numbers, from a national registry office). The personal ID number would (or should) then be used with all manufacturers of drugs and assorted products. It should be noted that many electronic products already have serial numbers on them, such as computers, televisions, telephones, et cetera.

### Computer Verification Method (FIG. 1)

In one embodiment, the consumer purchases the drugs from a drug store, along with a small label or card about one inch by two inches (1″ by 2″) that was supplied by the drug manufacturer, for the particular drug. The card or label includes a sequential serial number (SSN) created by the manufacturer for the particular drug. In addition to the sequential serial number, many other pieces of information are also included on the card, as will be described presently. The drug store, or the consumer, may contact the manufacturer by using a previously assigned manufacturer's identification (ID) number that was assigned by the drug manufacturer for purposes of verifications or authenticity of their drugs. In the case of the drug store contacting the manufacturer, the drug store should supply a printout of the manufacturer's reply, verifying the authenticity (or lack thereof) of the pharmaceutical product. Each batch of drugs supplied to the drug store may have the same sequential serial number for a certain specified number of pills or capsules, say, batches of 100 or so.

### Telephone Verification Method (FIG. 2)

In another preferred embodiment, the consumer may elect to call a toll free number of the drug manufacturer and obtain a verbal approval or rejection of the drug, by supplying, the above-mentioned, sequential serial number (SN) which was created by the manufacturer, along with his or her “personal identification number,” (which is optional).

### Dye Verification Method (FIG. 3)

In another preferred embodiment, the drug manufacturer would supply a small bottle with an eyedropper (inside the bottle), filled with a non-toxic dye (or other type of dispenser) and a paper dye strip, (free or for a nominal fee). A small drop of the non-toxic dye would then be placed onto a pill (the pill or capsule may have to be opened or spliced). The dye should change to a predetermined color upon the dye making contact with the pill or capsule. The resulting dye color needs to match the color of the paper dye strip that was supplied by the drug manufacturer, to verify that the drug is authentic

### Pill or Capsule Submerged into Dye Method (FIG. 4)

In another preferred embodiment, the spliced pill or capsule is dropped into a container of non-toxic dye. The dye should change to a predetermined color that should match the color of a paper dye strip that was supplied by the manufacturer, to thus verify the drug is authentic. This dye embodiment described immediately above, will provide proof that the pharmaceutical product is authentic and safe to consume. If there is not a match, then the consumer will know that the pharmaceutical product is most likely counterfeit.

### Individual Packaging Method (FIG. 5)

In another embodiment, the pills or capsules could be packaged in their own, sealed plastic package such as small candies are packaged. Each package could have its own manufacturer's serial number and contain only one pill or capsule. This package would stand by itself as the only one with it's own serial number plus its name, strength (mg), date, etc.

### Individual Packaging Method for Pain Killing Drugs (FIG. 5a)

It is suggested (or it may be mandated by law) that all pain pills/capsules should either be individually packaged, with serial numbers for each, or packaged in bubble packets of approximately 10-30 each, with one serial number for each bubble packet. Further, it should be, mandated by law, that no consumer be allowed to purchase such serial numbered packets unless he or she supplies his or her personal ID number at the time of purchase.

This would seriously curtail the excessive and illegal dispensing of all pain-killing drugs. The drug manufacturer would set up its computer in such a way that when sales to a particular consumer exceeds a predetermined amount of pain killers, during an allotted time frame, the computer would flag or alert the manufacturer, and the drug retailer, that there was an excessive amount of sales to a particular consumer.

It should be mandated, by law, that all drug manufacturers, drug wholesalers and drug retailers register with a central registry (or the FDA) so that a consumer would be prevented from getting pain prescriptions filled from different drug retailers around the country, regardless of which doctor made out the prescription for the pain killers. All drug pharmacies should have their computers connected so that they are linked, or connected, to each other so that they will communicate with each other, from a nationwide database, before the dispensing of pain killer medications.

### Manufacturer's Recall System

In the event of a manufacturer's “recall”, the serial numbered system would allow the manufacturer to locate the consumer and the drug retailer immediately, if the consumer had supplied his or her personal ID number.

The counterfeit pharmaceutical product detection method and system may be used in connection with both prescription and over the counter pharmaceutical products.

### BRIEF DESCRIPTION OF THE DRAWINGS

FIG. 1 is a flow chart showing a first embodiment of the counterfeit pharmaceutical product detection method wherein a consumer verifies the authenticity of the pharmaceutical product by typing in the drug manufacturer's identification code (I.D.) and other information into his or her computer.

FIG. 1A is an enlarged view of an insert.

FIG. 2 is a flow chart showing a second embodiment of the counterfeit pharmaceutical product detection method wherein a consumer verifies the authenticity of the pharmaceutical product by calling the drug manufacturer over the phone.

FIG. 3 is a flow chart showing a third embodiment of the counterfeit pharmaceutical product detection method wherein the drug manufacturer provides a testing strip, a non-toxic dye in a bottle, and an eyedropper. A drop of the non-toxic dye is placed on the pill or capsule and the consumer waits for a color change. If the color of the pill or capsule matches the color of the testing strip, then the consumer will know that the pharmaceutical product is authentic.

FIG. 4 is a flow chart showing a fourth embodiment of the counterfeit pharmaceutical product detection method wherein the drug manufacturer provides a pharmaceutical product, a non-toxic dye, and a testing strip. The consumer submerges the pill or capsule into the dye and waits for a color change. If the color change matches the color of the testing strip, then the consumer knows the pharmaceutical product is authentic.

FIG. 5 is a front elevational view showing a fifth embodiment of the counterfeit pharmaceutical product detection method and system having individualized packaging for the pharmaceutical product.

FIG. 5A is a front elevational view showing a sixth embodiment of the counterfeit pharmaceutical product detection method having a bubble packet with a unique bubble packet serial number for use in connection with pain killing pills and capsules.

### DETAILED DESCRIPTION OF THE INVENTION

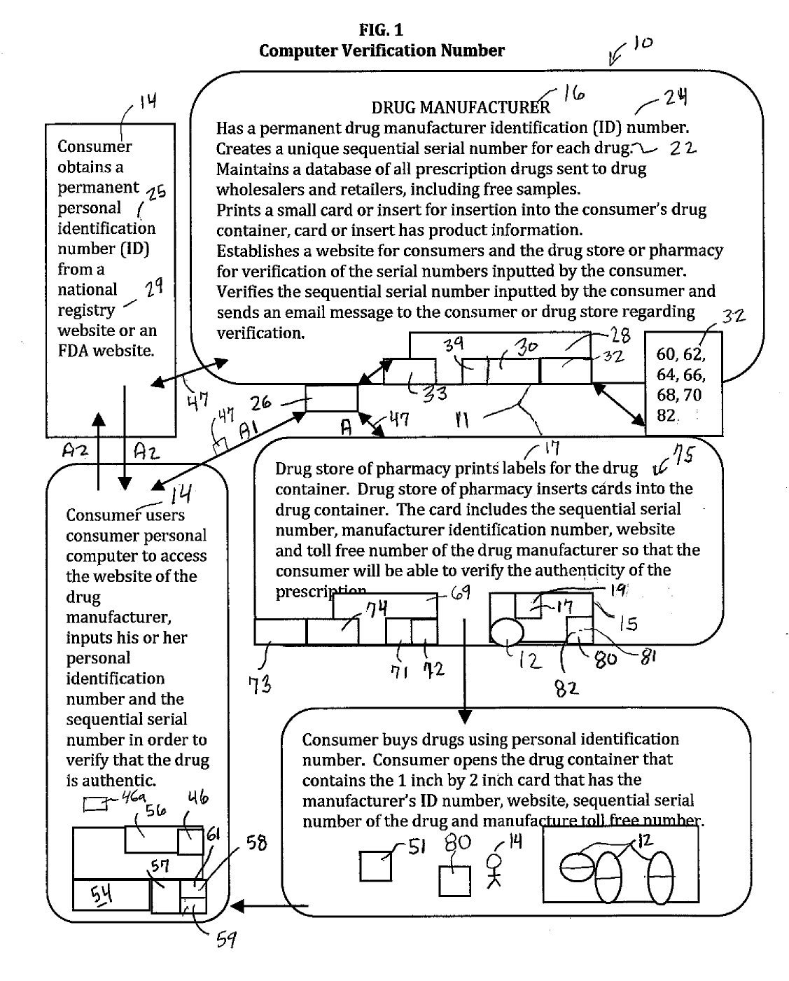

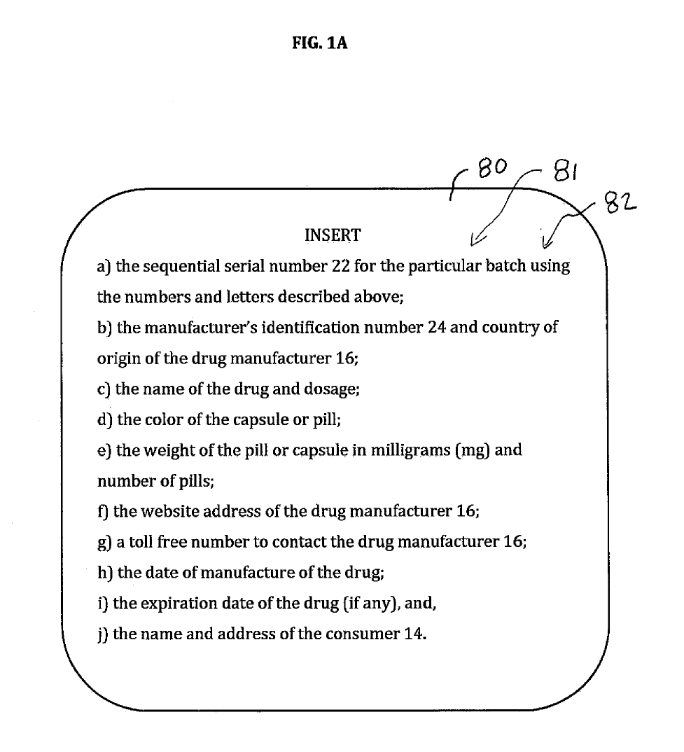

FIG. 1 is a flow chart depicting the counterfeit pharmaceutical product detection method 10. The counterfeit pharmaceutical product detection method 10 prevents pharmaceutical products 12 (sometimes referred to herein as drugs, pills and/or capsules 12) from being ingested by a consumer 14. The process begins with the drug manufacturer (or pharmaceutical company) 16 that manufactures the pharmaceutical products 12. The pharmaceutical products 12 shown in FIG. 1 are housed in a pill container 15.

The drug manufacturer 16 creates a sequential serial number 22 for each drug 12, a drug manufacturer identification number 24 (which can also be embodied as a drug manufacturer's code), and a drug manufacturer website 26. The manufacturer's identification number 24 identifies the particular drug manufacturer 16 that manufactured the pharmaceutical product 12. The sequential serial numbers 22 are preferably all different. Each serial number 22 is in the form of numerals, or can be embodied in the form of a combination of numerals and letters or symbols, or combinations thereof. In one of the preferred embodiments the sequential serial number 22 is four characters long, but may be more or less than four characters long in other preferred embodiments. The manufacturer identification number 24 of the drug manufacturer 16 is a series of four numbers or characters. It is pointed out that in one of the preferred embodiments the sequential serial number 22 and the manufacturer identification number 24 are created in such a manner that they do not include the letters B, C, D, E, M, N, P, T, V, Z because these letters may lead to confusion when they are pronounced in that they may sound like a different letter.

The counterfeit pharmaceutical product detection method 10 includes a system 11 for carrying out the process of detecting counterfeit pharmaceutical products. In particular, the drug manufacturer 16 has a programmed drug manufacturer general purpose computer 28 having a central processing unit 30 and a memory component 32. The programmed drug manufacturer general purpose computer 28 generates the sequential serial number 22.

As shown in FIG. 1 the memory component 32 is for storing data including at least the following:

drug manufacturer data 60;

sequential serial number data 62;

prescription drugs shipped to drug wholesalers data 64;

prescription drugs shipped to drug store retailers data 66;

drug detail data 68 that includes data pertaining to the drug name, color of pills or capsules, weight of pills or capsules, number of pills or capsules, date of manufacture and the expiration date of the pills or capsules (if any);

free sample prescription drug samples shipped to drug wholesalers and retailers data 70; and,

prescription data 82.

The central processing unit 30 uses and processes the drug manufacturer data 60; sequential serial number data 62; prescription drugs shipped to drug wholesalers data 64; prescription drugs shipped to drug store retailers data 66; drug detail data 68 that includes data pertaining to the drug name, color of pills or capsules, weight of pills or capsules, number of pills or capsules, date of manufacture and the expiration date of the pills or capsules (if any); free sample prescription drug samples shipped to drug wholesalers and retailers data 70, and prescription data 82. The central processing unit 30 is capable of generating outputs 45, for example an email 46 that can be printed and screen displays that can be viewed on a general purpose screen display 39 associated with the a programmed drug manufacturer general purpose computer 28. There is also a drug manufacturer general purpose computer interface component 33 to allow access to the Internet 47.

The programmed drug manufacturer general purpose computer 28 is accessible with a drug store computer 69 over the Internet 47 as designated by arrow A. The drug store computer 69 is located in a drug store or pharmacy 75. The drug store computer 69 has a drug store computer central processing unit 71 and a drug store computer memory component 72. There is also a drug store interface component 73 to allow access to the Internet 47. The drug store computer 70 generates outputs displayable on the drug store screen display 74 that is located in the drug store or pharmacy 75. The programmed drug manufacturer general purpose computer 28 is capable of transmitting and receiving information with the drug store computer 69 over the Internet 47.

The consumer 14 obtains a permanent personal identification number 25 from a national registry website 29 or from the Food and Drug Administration (FDA) as indicated by the arrows designate A2. The consumer 14 has a programmed personal consumer, computer 54 that has a personal consumer computer central processing unit 57, a personal computer memory component 58 and a consumer computer interface component 59 for allowing access to the Internet 47 (designated by the arrow A1). Outputs from the programmed personal computer 54 can be displayed on a consumer personal computer screen display 56.

Central processing units, memory components and interface components such as the ones described above units and their use and operation are well known to those having ordinary skill in the art and are therefore not described in greater detail. In addition, the act of programming a computer, for example the programmed drug manufacturer general purpose computer 28, to execute instructions in order to carry out the functions described herein is well known to those having ordinary skill in the art and is therefore not described in greater detail herein. And, the above-described screen displays may be embodied as other graphical user interfaces known to those having ordinary skill in the art. Interface components are well known to those having ordinary skill in the art and can include any combination of hardware, firmware, or software in a computer used to enable communication or data transfer between the computer and a device, system, or network external to the computer. The interface components can connect with a system, or network external to the programmed drug manufacturer general purpose computer 28, using, for example, an Internet connection, and all of these types of connections are well known to those having ordinary skill in the art.

In use, when a consumer 14 goes the drug store or pharmacy 75 to have a prescription 51 filled, he or she tenders a prescription 51 to the pharmacist. The consumer 14 provides his or her personal identification number 25 to verify who he or she is to the pharmacist. The pharmacist then accesses the drug manufacturer website 26, inputs the sequential serial number 22 data for the pharmaceutical product 12, and inputs data 68 pertaining to the prescription 51. In response, the programmed drug manufacturer general purpose computer 28 sends a response to the drug store computer 69 indicating that the inputted data is valid or invalid. If the inputted information is valid the pharmacist then prints a label 17 and joins the label 17 to the pill container 15, or a box or a bottle depending on how the pharmaceutical product 12 is packaged. The label 17 has printed indicia 19 printed thereon. The printed indicia 19 includes the name (and address) of the consumer 14, the sequential serial number 22, the manufacturer identification number 24, and the address for the drug manufacturer's website 26 and additional useful information, such as the number of pills or capsules 12 in the pill container 15, an expiration date, the dosage and the weight expressed in milligrams of the pills or capsules 12. In one of the preferred embodiments the portion of the drug manufacturer's website 26 the pharmacist accesses is password protected

In addition, the drug manufacturer 16 prints a small card or insert 80 that includes important pharmaceutical product information and provides the cards and inserts 80 to the drug store 31 (or the drug store 31 itself may print the inserts 80). FIG. 1A is an enlarged view of the insert 80. The pharmacist places the insert 80 in the pill container 15. As shown in FIG. 1A, the insert 80 has printed indicia 81 printed thereon that includes the following prescription data 82:

a) the sequential serial number 22 for the particular batch using the numbers and letters described above;

b) the manufacturer's identification number 24 and country of origin of the drug manufacturer 16;

c) the name of the drug and dosage;

d) the color of the capsule or pill;

e) the weight of the pill or capsule in milligrams (mg) and number of pills;

f) the website address of the drug manufacturer 16;

g) a toll free number to contact the drug manufacturer 16;

h) the date of manufacture of the drug;

i) the expiration date of the drug (if any), and,

j) the name and address of the consumer 14.

The pharmaceutical drugs 12 are then sold to the consumer 14. After the consumer 14 leaves the drug store 75 he or she may at any time use his or her own personal consumer computer 54 and access the drug manufacturer's website 26 and input the sequential serial number 22 and his or her personal identification number 25 appearing on the insert 80. This information is transmitted over the Internet 47 as indicated by the arrow designated A1 to the drug manufacturer 16. The response from the drug manufacturer 16 causes prescription data 82 to be displayed on the consumer personal computer screen display 56 and can include an email 46 that is sent to and appears on the consumer personal computer screen display 56. The information on the insert 80 should match the prescription information appearing on the consumer personal computer screen display 56 or on the email 46. The consumer 14 immediately knows the pharmaceutical product 12 is counterfeit if the information appearing on the consumer personal computer screen display 56 or on the email 46 does not match the printed indicia 81 on the insert 80. If the pharmaceutical product 12 is counterfeit, then the consumer 14 may immediately return to the drug store 75, present a printed copy of the printed email 46a, and alert the drug store 75 of the problem, or he or she can call or he or she may e-mail the drug manufacturer 16 and alert it of the problem.

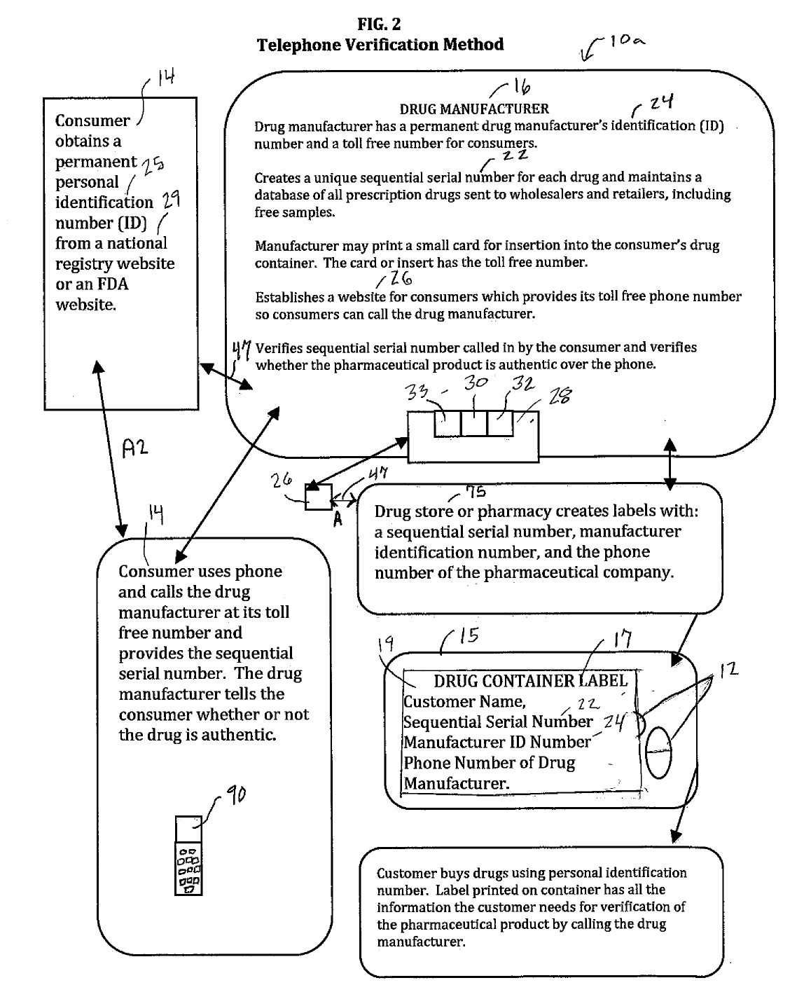

FIG. 2 shows a second embodiment of the counterfeit pharmaceutical product detection method and system 10a for verifying the authenticity of pharmaceutical products 12 that is similar to the first embodiment. Here, after the consumer 14 purchases the pharmaceutical product 12 and calls the drug manufacturer 16 with his or her phone 90. Next the consumer 14 inputs the sequential serial number 22 and optionally his or her personal identification number 25 by pressing the appropriate buttons on the phone 90 or verbally providing this information over the phone.

If there is a problem and it appears the drug 12 is counterfeit, then the pharmacists at the drug store 75 will call the toll free number and input the sequential serial number 22 and optionally personal identification number 25 to verify the consumer 14 inputted the number properly. If the consumer 14 plans on phoning in the sequential serial number 22, then the consumer 14 may identify himself or herself to the pharmacy clerk at the time of purchase and provide the clerk with his or her phone number. This will allow the drug store 75 to only associate that one particular phone number with the consumer 14. The consumer 14 will only be allowed to call in for verifications for that specific phone number or they will be turned away as a risk. This provides for an extra level of security.

In another preferred embodiment, the consumer 14 may call a toll free line at the FDA, and the FDA would verify whether the prescription is authentic or counterfeit. Here, the programmed drug manufacturer's computer 28 is in transmits and receives information with the drug store computer 70 and the computers of the FDA over the Internet 47 as indicated in FIG. 1.

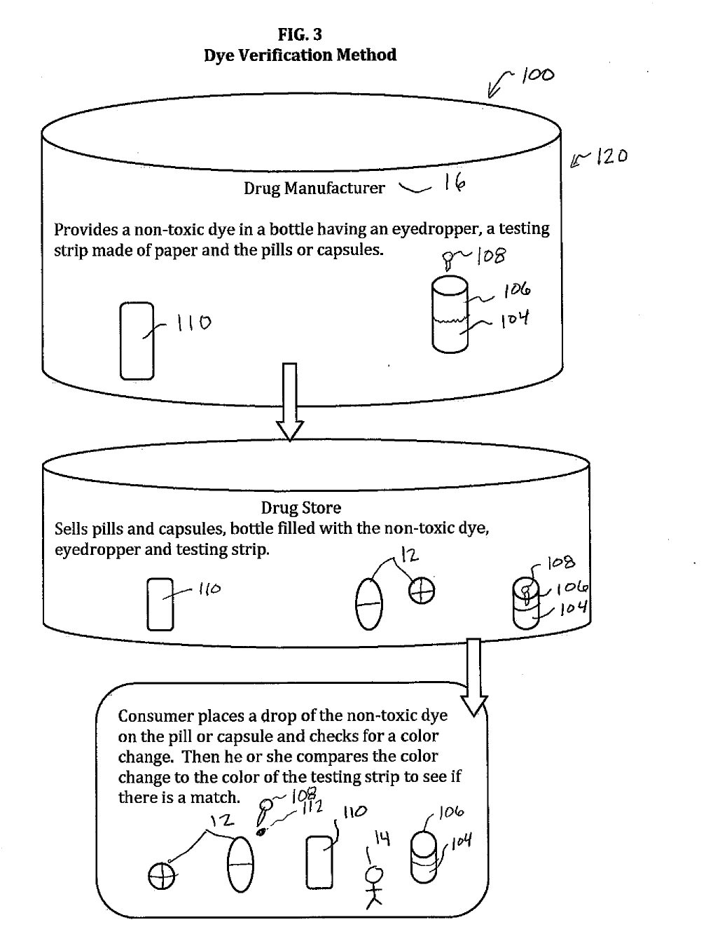

FIG. 3 shows a third embodiment of the counterfeit pharmaceutical product detection method and system 100 for preventing pharmaceutical products 12 that are counterfeit from being ingested or otherwise used by the consumer 14. The drug manufacturer 16 provides a non-toxic dye 104 in a bottle 106 having an eyedropper 108, along with a colored testing strip 110 that may be made of paper. The bottle 106 contains a non-toxic dye 104 that is capable or reacting with the pill or capsule 12. The non-toxic dye 104 may be clear or colored. The consumer 14 takes the eyedropper 108 and drops a drop 112 of the non-toxic dye 104 on the pill or capsule 12 (which the consumer 14 may need to slice or splice in advance of conducting the test). The non-toxic dye 104 reacts with the pill or capsule 12 and is designed to change a predetermined color upon contact with the pill or capsule 12. The consumer 14 and observes whether or not the pill or capsule 12 changes to the predetermined color of the testing strip 110 (which may also be indicated on the label 17 of the pill container 15). If it does, then the consumer 14 will immediately know the pill or capsule 12 is authentic. If the pill or capsule 12 fails to turn the proper color, then the consumer 14 can report this to the drug store 75, the drug manufacturer 16 or the FDA. The consumer 14 also knows not to ingest the pill or capsule 12.

The non-toxic dye 104 disposed in the bottle 106, the eyedropper 108, and the colored testing strip 110 that may be made of paper can be sold by the manufacturer as a kit 120.

Methods for causing color changes in the above-described manner are well known to those having ordinary skill in the art.

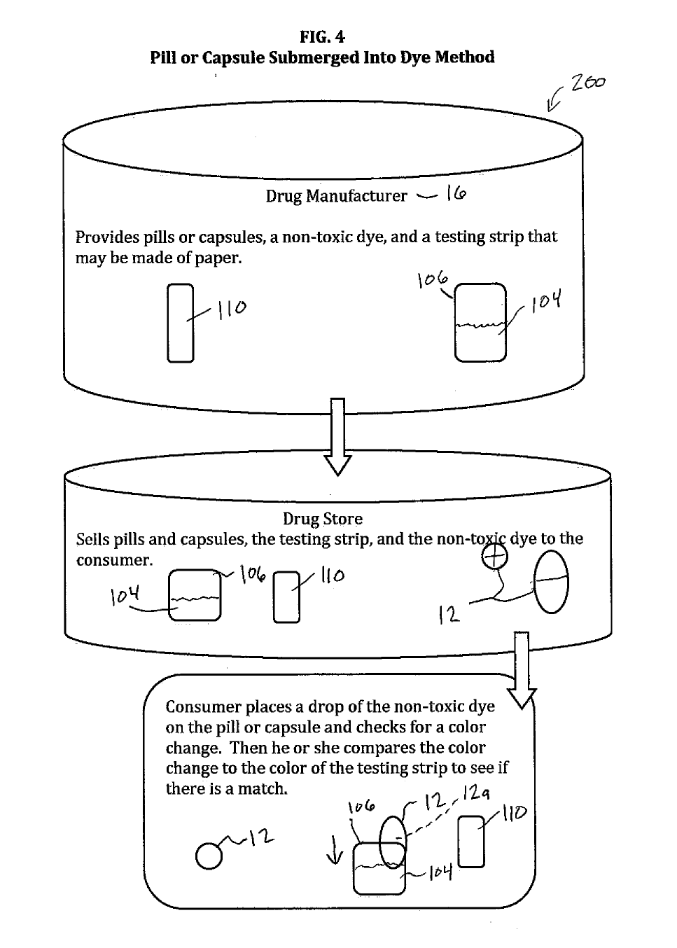

FIG. 4 shows a fourth embodiment of the counterfeit pharmaceutical product detection method and system 200. The drug manufacturer 16 manufactures pills and capsules 12, a non-toxic dye 104, and colored testing strips 110. AU the consumer 14 needs to do is to submerge the pill or capsule 12 into the non-toxic dye 104 and check whether there is a color change, that is, a reaction. If there is and the color change in the non-toxic dye 104 that matches the predetermined color indicated on the testing strip 110 (which may also be indicated on the label 17 of the container 15), then the consumer 14 will immediately know the pill or capsule 12 is authentic. If there is no color change or the wrong color change, then the consumer 14 will known that the pill or capsule 12 is a counterfeit pill or capsule 12a and can report this to the drug store 75, the drug manufacturer 16 or the FDA. The consumer 14 also knows not to ingest the pill or capsule 12. Methods for causing color changes in the above-described manner are well known to those having ordinary skill in the art.

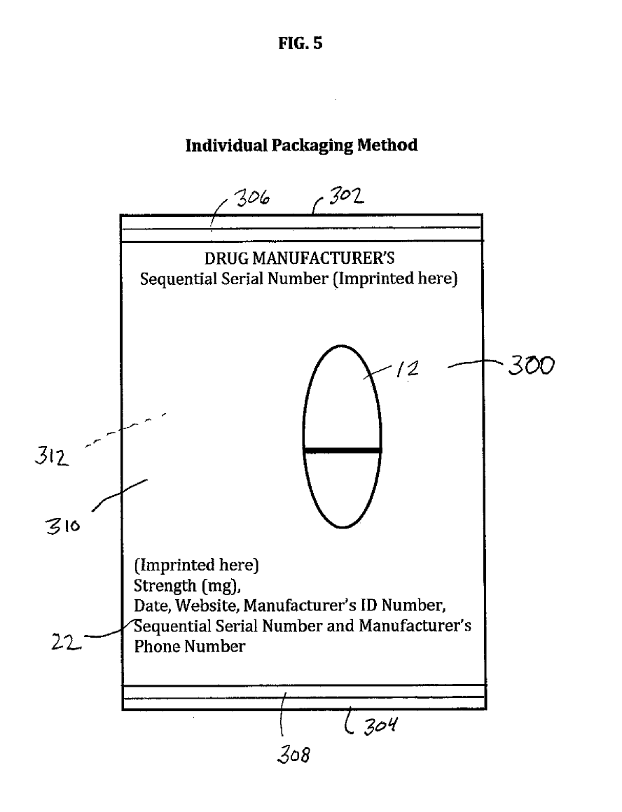

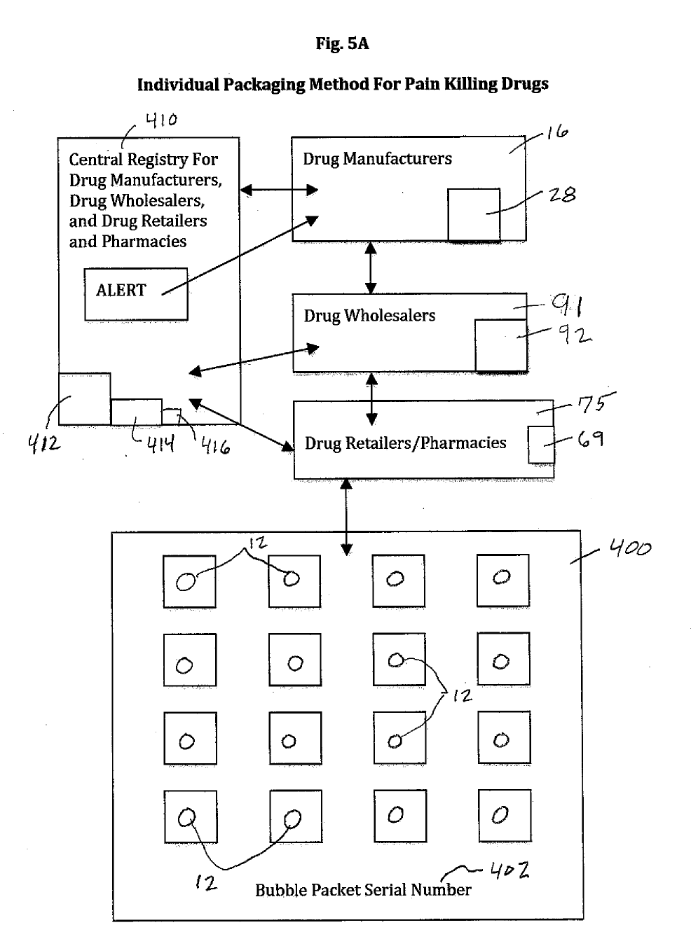

FIG. 5 is a fifth embodiment wherein the pill or capsule 12 is individually packaged in a package 300. The package 300 has printed thereon the sequential serial number 22. The packages 300 may be made of a clear plastic material and has opposed ends 302, 304 that are heat sealed or glued along the end seams 306, 308. The package 300 also has opposed sidewalls 310, 312 that are transparent and define a package interior 314 that houses the pill or capsule 12. The consumer 14 may verify whether the pills or capsules 12 are authentic via the sequential serial number 22 in the manner previously described in connection with the first embodiment described herein.

As shown in FIG. 5A, in another preferred embodiment an individual packaging method is shown for use in connection with pain killing pills and capsules 12. The pills and capsules 12 are held in a bubble packet 400. The bubble packet has is own unique bubble packet serial number 402 that exactly identifies that bubble packet 400. The drug manufacturers' programmed drug manufacturer general purpose computers 28; the drug wholesalers' computers 92 owned by drug wholesalers 91, and the drug store computer 69 owned by the drug retailers such as the drug store or pharmacy 75 are capable of transmitting and receiving information between one another and with a central registry 410. The central registry 410 has a programmed central registry computer 412 with a registry memory component 414 and a registry central processing unit 416 that keeps track of all personal identification numbers 25 and bubble packet serial numbers 402. The programmed central registry computer 412 continuously monitors and tracks each bubble packet 400 via the unique bubble packet serial number 402 to ensure that the same personal identification number 25 is not being used excessively to purchase pain killers. If a personal identification number 25 is being used excessively, then an alert goes out to the all the drug manufacturers 16, drug wholesalers 91 and drug retailers 75 and future sales to that individual are stopped immediately. A suitable investigation of that consumer 14 and/or drug retailer 75 may be started immediately. Thus, the ability of the consumer 14 to purchase excessive amounts of pills and capsules is effectively terminated. It is to be understood that other packaging for the pills and capsules 12 may be used in connection with this embodiment.

It is pointed out the a counterfeit pharmaceutical product detection method 10 advantageously can be used to track drugs 12 that are counterfeit, prevent the ingestion of drugs that are counterfeit 12, and allow for the tracking of pharmaceutical products 12 from the drug manufacturer 16 to the consumer 14.

In addition, the method of controlled tracking of pharmaceutical products 12 provides a way to control and stop unscrupulous drug stores 75 from selling narcotic drugs and other addictive drugs to people not entitled to have such pharmaceutical products 12. And, the counterfeit pharmaceutical product detection method 10 may be used in connection with over the counter drugs. In such an embodiment the sequential serial number 22 and manufacturer identification number 24 would be included internally in the product packaging. A consumer 14 uses the telephone 90 and calls in a particular serial number 22 to the drug manufacturer 16 (or inputs the serial number 22 over the Internet 47 into the programmed drug manufacturer general purpose computers 28 of the drug manufacturer 16). If another consumer 14 has already inputted the same information, then the drug manufacturer 16 and the consumer 14 will know the pharmaceutical product 12 is counterfeit.

In any instance where the drug store 75 provides the verification it should provide the consumer 14 with a printout of the verification received from the drug manufacturer 16.

It will be appreciated by those skilled in the art that while a counterfeit pharmaceutical product detection method 10 has been described in detail herein, the invention is not necessarily so limited and other examples, embodiments, uses, modifications, and departures from the embodiments, examples, uses, and modifications may be made without departing from the counterfeit pharmaceutical product detection method 10 and all such embodiments are intended to be within the scope and spirit of the appended claims.

What is claimed is:

1. A counterfeit pharmaceutical product detection method comprising the acts of:
providing a manufacturer of a pharmaceutical product and providing the manufacturer with a manufacturer identification code;
identifying the pharmaceutical product with a sequential serial number;
providing a consumer with a prescription for the pharmaceutical product;
providing a drug store wherein the consumer provides a prescription to the drug store and the drug store filling the prescription and providing the pharmaceutical product to the consumer;
wherein the drug store provides the consumer with a card having printed indicia pertaining to the prescription; and,
allowing the consumer to verify whether the pharmaceutical product is authentic or counterfeit by using the printed indicia on the card accompanying the pharmaceutical product.

2. The counterfeit detection pharmaceutical product according to claim 2 wherein the pharmaceutical product includes pills and capsules.

3. The counterfeit detection pharmaceutical product according to claim 1 wherein the printed indicia appearing on the card provided to the consumer includes at least the following printed indicia:
the sequential serial number along with a particular batch using the numbers and letters described above;
the manufacturer identification code and a country of origin of the drug manufacturer;
the name of the pharmaceutical product and a dosage;
an indication of a color of the pills and capsules;
a weight expressed in milligrams of the pills and capsules and the number of pills or capsules;
a website address of the drug manufacturer;
a toll free number to contact of the drug manufacturer so the consumer can call the drug manufacturer;
a date of manufacture of the pharmaceutical product;
an expiration date of the pharmaceutical product; and,
personal information pertaining to the consumer including a name and an address of the consumer.

4. The counterfeit detection pharmaceutical product according to claim 1 wherein the act of providing a manufacturer with a manufacturer identification code and providing the product with a sequential serial number includes using letters but for the letters B, C, D, E, M, N, P, T, V, Z.

5. The counterfeit detection pharmaceutical product according to claim 3 wherein the act of allowing the consumer to verify whether the pharmaceutical product is authentic or counterfeit includes providing the consumer with a personal consumer computer with the consumer accessing the website of the drug manufacturer and inputting the sequential serial number appearing on the card and a personal identification number appearing on the card and receiving a response from the drug manufacturer pertaining to pharmaceutical product associated with the sequential serial number inputted by the consumer.

6. The counterfeit detection pharmaceutical product according to claim 5 wherein the consumer compares the response from the drug manufacturer pertaining to pharmaceutical product with the printed indicia appearing on the card and visually determines if there the response from the drug manufacturer pertaining to pharmaceutical product matches the printed indicia appearing on the card to determine whether the pharmaceutical is counterfeit or not counterfeit.

7. The counterfeit detection pharmaceutical product according to claim 6 further wherein when the response received from the drug manufacturer pertaining to pharmaceutical product associated with the sequential serial number inputted by the consumer is in the form of an email, and printing the email if the response and the printed indicia on the card do not match and presenting the printed email to the drug store and alerting the drug store that the pharmaceutical product is counterfeit and obtaining a refund from the drug store.

8. The counterfeit detection pharmaceutical product according to claim 7 where the act of allowing the consumer to verify whether the pharmaceutical product is authentic or counterfeit by using the printed indicia on the card accompanying the pharmaceutical product further includes providing the phone number of the manufacturer on the card and providing the consumer with a phone wherein the consumer calls the manufacturer and provides the printed indicia on the card and the manufacturer and the manufacturer provides a response to the consumer as to whether the pharmaceutical product is counterfeit.

9. A counterfeit pharmaceutical product detection product comprising:
a bottle filled with a non-toxic dye,
an eyedropper for use in connection with the non-toxic dye; and
a colored testing strip,
wherein the eyedropper is for dispensing a drop of the non-toxic dye taken from the bottle by the eyedropper such that a color change of a pill to be tested due to the non-toxic dye applied on therein can be compared to the colored testing strip such that if the color of the testing strip matches the color of the pill to be tested then the pill is not counterfeit.

10. A counterfeit pharmaceutical product detection product according to claim 9 wherein the pill to be tested is submerged in the non-toxic dye and compared to the colored testing strip such that the eyedropper is not needed.

11. A counterfeit pharmaceutical product detection product comprising:
a manufacturer;
a pill produced by the manufacturer;
a package that is sealed and wherein the pill is disposed inside the package;
a sequential serial number printed on the package such that a consumer can verify whether the pill is counterfeit by contacting the manufacturer and providing the sequential serial number to the manufacturer

12. The counterfeit pharmaceutical product detection product according to claim 11 further wherein the package is a bubble packet and the sequential serial number is replaced with a unique bubble packet serial number that exactly identifies the bubble packet.

13. The counterfeit pharmaceutical product detection product according to claim 12 further including:
programmed drug manufacturer general purpose computers owned by drug manufacturers;
programmed drug wholesaler computers owned by drug wholesalers;
programmed drug retailer computers owned by drug retailers;
wherein the programmed drug manufacturer general purpose computers, the drug wholesalers computers and the retailer computers are capable of transmitting and receiving information from one another and are each capable of transmitting and receiving information with a central registry having a programmed central registry computer with a processor and memory component for storing an processing data pertaining to unique bubble packet serial numbers.

14. The counterfeit pharmaceutical product detection product according to claim 13 further including:
wherein the pill is a pain killing pill; and,
wherein the programmed central registry computer is for continuously monitoring and tracking each bubble packet via the unique bubble packet serial number and sending an alert to the drug manufacturers, drug wholesalers and drug retailers if the programmed central registry computer detects a consumer is using the pain killing pill excessively so that the excessive use by the consumer is stopped or investigated.
